(19) United States
(12) Patent Application Publication
(10) Pub. No.: US 2003/0190936 A1
(43) Pub. Date: Oct. 9, 2003

(54) Charge socket for hands-free cellular phone in vehicle

(76) Inventors: Chen-Chao Fan, Chungli City (TW); Ming-Jane Hsieh, Taipei (TW)

Correspondence Address: BACON & THOMAS, PLLC, 625 SLATERS LANE, FOURTH FLOOR, ALEXANDRIA, VA, 22314

(21) Appl. No.: 10/094,705

(22) Filed: Mar. 12, 2002

(51) Int. Cl. H04M 1/00; H04B 1/38

(52) U.S. Cl. 455/573; 455/569.2; 455/572

(57) ABSTRACT

A charge socket is provided with a charge coupling having a tubular member, which has an expandable portion and a bearing socket at one end, in which an openable notch is arranged in its lateral wall. A ferrule is clad on the tubular member and allowed to be moved along that tubular member axially. A sphere of a clamp means might be embedded in the bearing socket and permitted to rotate freely for adjustment of the angle between the clamp means and the charge coupling. When the ferrule is displaced to the position of the expandable portion of the tubular member, the tube wall of the bearing socket is forced to clamp the sphere tightly to forbid rotation thereof.

### FIELD OF THE INVENTION

This invention relates generally to a socket for fixing a hands-free cellular phone and charging it in a vehicle, particularly to such a charge socket, which is adjustable in its angle of inclination for easy installation of a cellular phone.

### BACKGROUND OF THE INVENTION

In the recent days a cellular phone is no longer a symptom of wealth, it seems very rare to meet people walking on the street without carrying a cellular phone. It is also said that the prevalence rate of cellular phone in an average developed country is about 90% according to marketing reports.

The cellular phone is indisputably instrumental to communications, however, it brings about a bad effect to traffic security on the other hand. For example, a driver could be distracted to probably incur a traffic accident by using a cellular phone when he is driving his car. Thus, for prevention of such a terrible accident, some makers have elaborated on a charge socket for a hands-free cellular phone in vehicle so that he can talk through his cellular phone without holding it and charge it automatically whenever it is put on the socket.

A conventional charge socket is usually equipped with a charge coupling and a clamp means, in which the charge coupling is provided for a user to plug it in a power jack while the clamp means is for clamping and fixing the cellular phone in place.

The conventional charge socket for cellular phone can only fixedly clamp a cellular phone in place while it doesn't satisfy all people for the reason of “different cars different positions of power jacks” and it fails to fully meet the requirements of ergonomics of different people because of their different statures. Thus, the conventional charge socket does need some improvements to make things easier.

### SUMMARY OF THE INVENTION

The primary objective of this invention is to provide a charge socket for hands-free cellular phone in vehicle, in which a turning device is arranged between a charge coupling of the charge socket and a clamp means such that the clamp means and the charge coupling are rotatable with respect to each other for adjusting the angle of a hands-free cellular phone and securing the same conveniently, and such that this invention can be set by people having different habits to fit in with themselves.

In order to realize foregoing objective, the charge socket is provided with a charge coupling having a tubular member, which has an expandable portion and a bearing socket at its one end, in which an openable notch is arranged in its lateral wall. A ferrule is clad on the tubular member and allowed to be moved along that member axially. Moreover, a sphere of the clamp means might be embedded in the bearing socket and permitted to rotate freely for adjustment of the angle between the clamp means and the charge coupling. When the ferrule is displaced to the expandable portion of the tubular member, the tube wall of the bearing socket is forced to clamp the sphere tightly to forbid rotation thereof.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows a charge socket for cellular phone of this invention in three dimensions;

FIG. 2 is an exploded view in three dimensions showing the relative positions of the main parts of the charge socket for cellular phone of this invention;

FIG. 3 shows a cutaway partial section of a secured architecture between a clamp means and a charge coupling of this invention;

FIG. 4 shows a cutaway partial section of a movable architecture between the clamp means and the charge coupling of this invention;

FIG. 5 is a three-dimensional view of an embodiment of this invention showing that an earphone conductive cord is striding a gap; and

FIG. 6 is a partial sectional view of this invention showing an adjustable distance between two clamping pieces, which are preferably arranged in different slide channels at different positions.

### DETAILED DESCRIPTION OF THE INVENTION

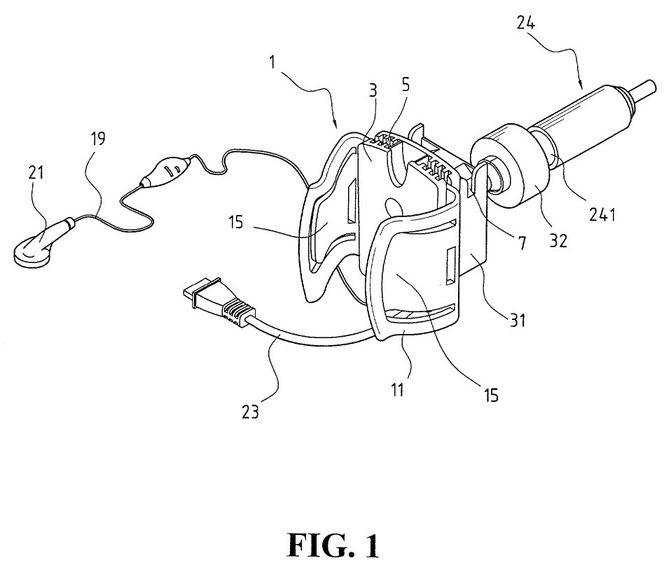

As illustrated in FIG. 1, a charge socket of this invention for hands-free cellular phone in vehicle comprises an assembly including a charge coupling 24 and a clamp means 1, in which the clamp means 1 is provided for clamping a cellular phone (also called a wireless mobile phone) and the given charge coupling 24 is supposed to be plugged in a power jack of vehicle (usually the cigarette lighter).

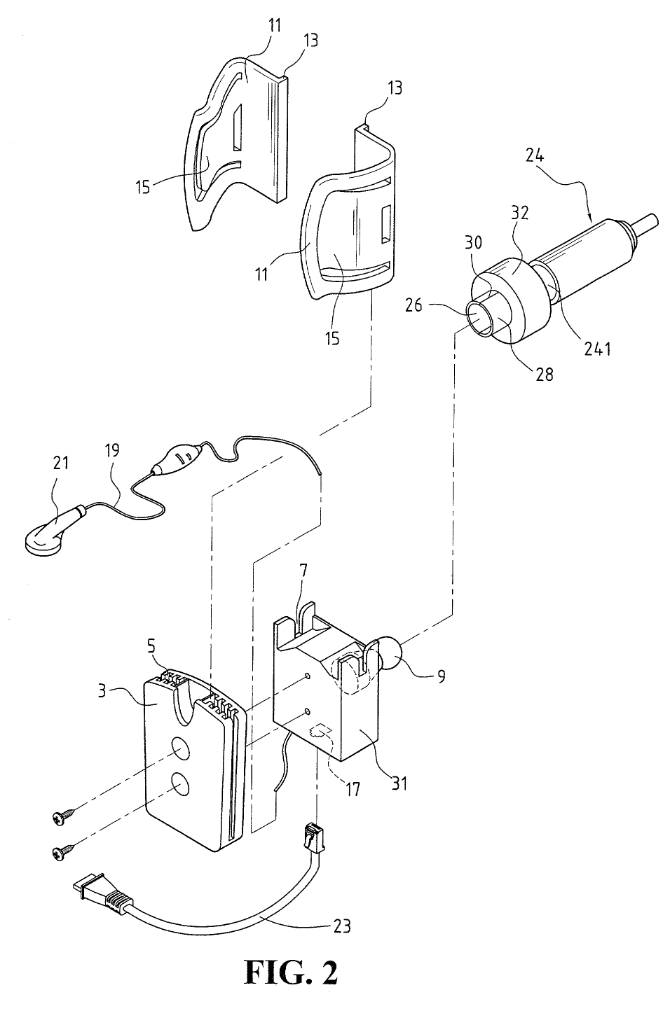

Now, referring to FIGS. 1 and 2, the clamp means 1 is provided with a plurality of parallel slide channels 5 formed symmetrically on both the right and the left sides respectively in its casing 3, in which the plurality of slide channels 5 is preferably aligned vertically. The casing 3 is joined to a charge box 31 on back, and a protruding sphere 9 is in turn joined to the charge box 31 by jointing itself with a rear outer lateral wall of the latter. Moreover, a gap 7 having its opening oriented upwardly is formed at the top end of each of two lateral walls of the charge box 31.

Also, an unshown charger is disposed in the charge box 31 and a terminal jack 17 for electrical connection with the inside charger and for receiving a power cord 23 is formed in a bottom edge of the charge box 31, in which the power cord 23 is supposed to be plugged in a charging port of a cellular phone. Besides, a conductive cord 19 of an earphone 21 is jointedly guided out of the charge box 31, and an aperture is arranged at an end portion of the sphere 9 to provide a passage for a conductive wire to pass through from the charge box 31 so as to joint with the charge coupling for conductive connection.

The clamp means 1 further comprises two sets of clamping piece 11. In a preferred embodiment, the clamping piece 11 is integrally and substantially shaped in character “L”, in which one end thereof is bent in a right angle to form a slide track 13 and a resilient portion 15 projecting inwardly is arranged in one side thereof so that the space defined between two installed resilient portions 15 will become capable of resiliently holding a cellular phone.

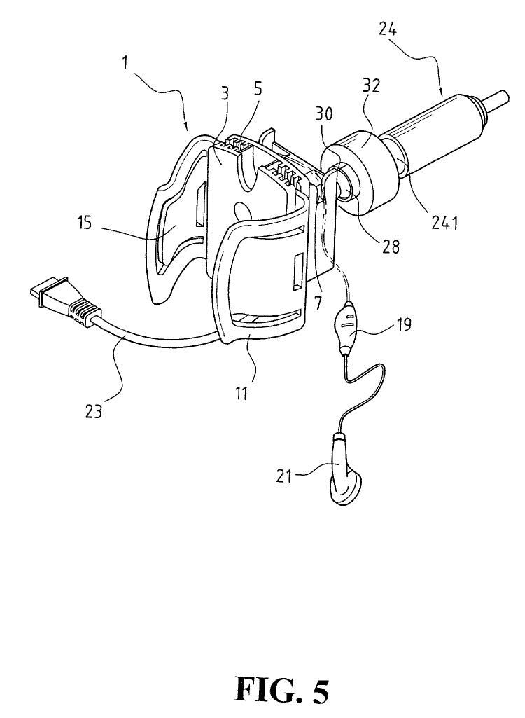

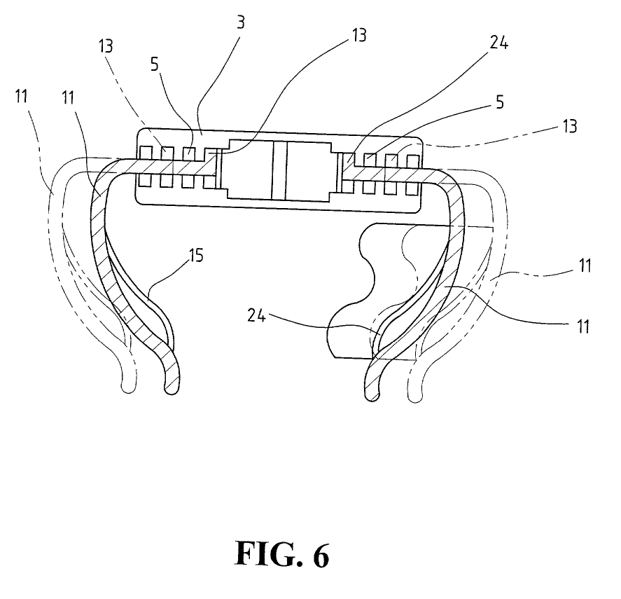

Referring to FIGS. 1, 5, and 6, the combination of the clamping piece 11 and the casing 3 could be made by sliding the slide track 13 of each clamping piece 11 into the casing 3 along a slide channel 5, in which it is possible for a user to choose a proper slide channel to adjust the distance between two clamping pieces for accommodating a cellular phone according to its brand, type, and measurements. As the slide tracks 13 and the slide channels 5 are mated overtight purposely, thus a frictional force is created to prevent those two clamping pieces 11 from getting loosened and swayed.

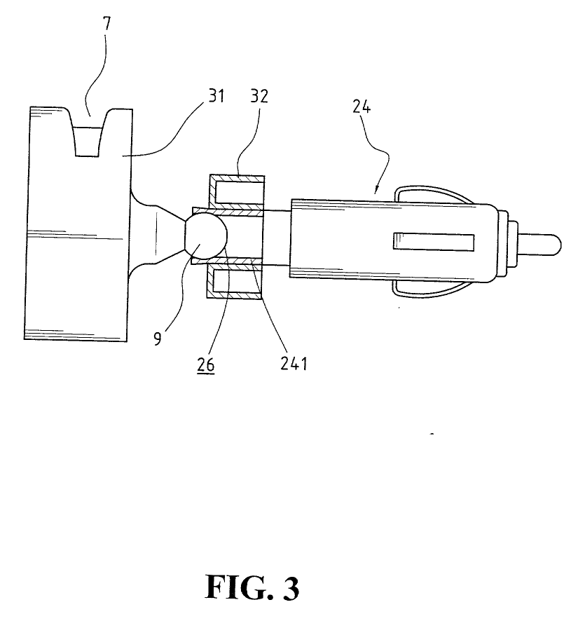

A tubular member 241 provided to the charge coupling 24 has an expandable portion 28 and a bearing socket 26 at one end thereof, in which an openable notch 30 is formed in the lateral wall of the bearing socket 26, which is a half spherical inner wall. The expandable portion 28 could be expanded under natural conditions of the tubular member 241 without any external force applied to thereby accommodate the sphere 9 and enable it to rotate freely in the bearing socket 26 as shown in FIG. 3 for adjustment of the angle of inclination of the clamp means 1 relative to the charge coupling 24.

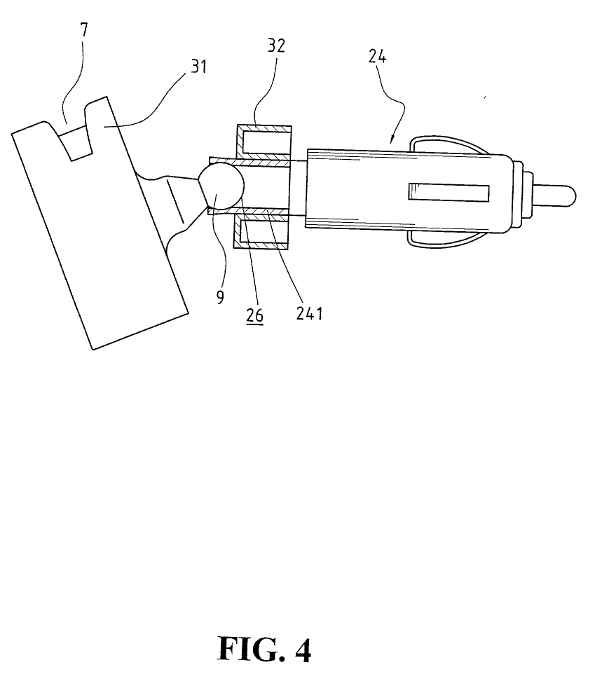

Furthermore, a ferrule 32 having an inner diameter approximately equal to the outer diameter of the tubular member 241 is mounted on the circumference of the tubular member and is movable along the central axis thereof. When the ferrule 32 is displaced to the expandable portion 28 of the tubular member 241, the lateral wall of the bearing socket 26 is forced to shrink and clamp the sphere 9 more tightly (shown in FIG. 4) so that the clamping pieces 11 would be secured to become nonrotatable with respect to the charge coupling 24. After use of the earphone 21, a user might have the conductive cord 19 lain straddling over the gap 7 on the top end of the charge box 31 for avoiding tangle or kink of the conductive wires for using next time.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A charge socket for hands-free cellular phone in vehicle, comprising a charge coupling and a clamp means; said charge coupling having a tubular member; one end of said tubular member being provided with a expandable portion and a bearing socket; a lateral wall of said bearing socket having an openable notch; a ferrule having an inner diameter approximately equal to the outer diameter of said tubular member and said ferrule being clad on the circumference of said tubular member such that said ferrule could be moved axially along said tubular member; said clamp means having a sphere and said sphere being permitted to be embedded in said bearing socket such that it is allowed to rotate freely in that bearing socket; and the tube wall of said bearing socket being forced to clamp said sphere tightly and forbid rotation thereof when said ferrule is displaced to the position of said expandable portion of said tubular member.
